(19) United States
(12) Patent Application Publication
(10) Pub. No.: US 2024/0105986 A1
(43) Pub. Date: Mar. 28, 2024

(54) COMPOSITION COMPRISING A SULFIDE ELECTROLYTE

(71) Applicant: RHODIA OPERATIONS, Lyon (FR)

(72) Inventors: Diego Lopez Gonzalez, Puteaux (FR); Thierry Le Mercier, Rosny-Sous-Bois (FR); Lauriane D'Alencon, Issy-Les-Moulineaux (FR); Laure Bertry, Aubervilliers (FR); Marc-David Braida, Bry-Sur-Marne (FR); Vincent Finsy, Halle (BE)

(73) Assignee: RHODIA OPERATIONS, Lyon (FR)

(21) Appl. No.: 18/263,097

(22) PCT Filed: Jan. 27, 2022
(86) PCT No.: PCT/EP2022/051936

§ 371 Date: Jul. 26, 2023

(30) Foreign Application Priority Data
Jan. 28, 2021 (EP) 21305113.9
Aug. 26, 2021 (EP) 21315145.9

(51) Int. Cl. H01M 10/0562; C01B 25/14; H01M 4/62; H01M 50/431; H01M 50/443; H01M 50/446

(52) U.S. Cl. CPC H01M 10/0562; C01B 25/14; H01M 4/62; H01M 50/431; H01M 50/443; H01M 50/446; C01P 2006/40; H01M 2300/008

(57) ABSTRACT

The invention relates to a Composition comprising or consisting essentially of a product according to formula (I): LiₐPS_{b}X_{c} (I) wherein—X represents at least one halogen element; —a represents a number from 2.0 to 7.0; —b represents a number from 3.5 to 6.0; and—c represents a number from 0 to 3.0; in the form of particles or articles the size of which being such that less than 10 wt % of the composition pass through a sieve of 200 μm.

This application claims priorities filed in EUROPE on 28 Jan. 2021 with Nr 21305113.9 and on 26 Aug. 2021 with Nr 21315145.9, the whole content of each of these applications being incorporated herein by reference for all purposes.

The present invention relates to a composition comprising a sulfide electrolyte and to its use for the preparation of a composition (C) used in the preparation of an electrode or of an electrolyte layer.

### TECHNICAL FIELD

A lithium battery is a battery having a structure in which lithium is dissolved as an ion from a positive electrode and occluded by a negative electrode through migration in charging, whereas the lithium ion is returned from the negative electrode to the positive electrode in discharging. A lithium secondary battery is widely used as a power source of home electric appliances, e.g., a video camera, portable electronic equipments, e.g., a notebook computer and a mobile phone, electric power tools, and the like due to such characteristics thereof as a large energy density and a long service life, and in recent years, is being applied to large capacity batteries mounted on an electric vehicle (EV), a hybrid electric vehicle (HEV), and the like. Lithium batteries are therefore used to power portable electronics and electric vehicles owing to their high energy and power density.

Lithium batteries make use of a liquid electrolyte that is composed of a lithium salt dissolved in an organic solvent. The aforementioned system raises security questions as the organic solvents are flammable. Lithium dendrites forming and passing through the liquid electrolyte medium can cause short-circuit and produce heat, which result in accident that leads to serious injuries.

Non-flammable inorganic solid electrolytes offer a solution to the security problem. Furthermore, their mechanical stability helps suppressing lithium dendrite formation, preventing self-discharge and heating problems, and prolonging the life-time of a battery.

Solid sulfide electrolytes of formula Li₆PS₅X wherein X is an halogen are advantageous for lithium battery applications due to their high ionic conductivities and mechanical properties (see Yosuke UKAWA, et al., “Preparation procedure of argyrodite-type Li₆PS₅X (X═Cl, Br, I) solid electrolytes and their ionic conductivity”, Symposium on Basic Science of Ceramics, January 2015 (1G18), the Ceramic Society of Japan). These electrolytes can be pelletized and attached to electrode materials by cold pressing, which eliminates the necessity of a high temperature assembly step. Elimination of the high temperature sintering step removes one of the challenges against using lithium metal anodes in lithium batteries.

### Technical Problem

A difficulty experienced with the solid sulfide electrolytes is that hydrogen sulfide (H₂S) is released when the material is in contact with humidity. Hydrogen sulfide has a pungent odor and is toxic so that safety measures need to be taken in the laboratory or in the plant to avoid the exposure to H₂S of the technicians. There is therefore a need for a solid sulfide electrolyte which releases a lower quantity of H₂S. Another difficulty is that solid sulfide electrolytes can be carbonated when exposed to carbon dioxide present in air, resulting in detrimental effects on ionic conductivity properties. There is also a need for solid sulfide materials under the form of free-flowing articles to facilitate transportation, comprising low amounts of dust to ensure safe handling and storage. Yet, the solid sulfide electrolyte still needs to be easily mixed and dispersed with a polymeric binder to prepare a composition used in the preparation of an electrode or of an electrolyte layer.

The invention aims at solving this technical problem.

### BACKGROUND ART

EP 2504879 B1 discloses a composition based on a sulfide electrolyte and an inhibitor of H₂S.

JP 2011165650 A2 discloses a composition based on a sulfide electrolyte and a base to trap H₂S.

EP 2732451 B1 discloses a method for producing a sulfide solid electrolyte material, comprising a step of adding an ether compound to a coarse-grained material of a sulfide solid electrolyte material and microparticulating the coarse-grained material by a pulverization treatment. The obtained product exhibits a much smaller size than the composition of the invention.

KR 102003300 B1 discloses particles of sulfide with an average size in the range 0.1 to 50 μm.

JP2019102412 A2 discloses a process of reduction of the size of particles of coarse particles of sulfide. The D50 of the coarse particles is 200 μm or less.

### BRIEF DESCRIPTION OF THE INVENTION

The invention relates to a composition as disclosed in claims 1 to 21. The invention also relates to a process of preparation of the composition as disclosed in claim 22 and to its use as disclosed in claim 23 or claim 24. These objects are now further described.

### FIGURES

FIG. 1/1 provides a picture of a composition according to the invention.

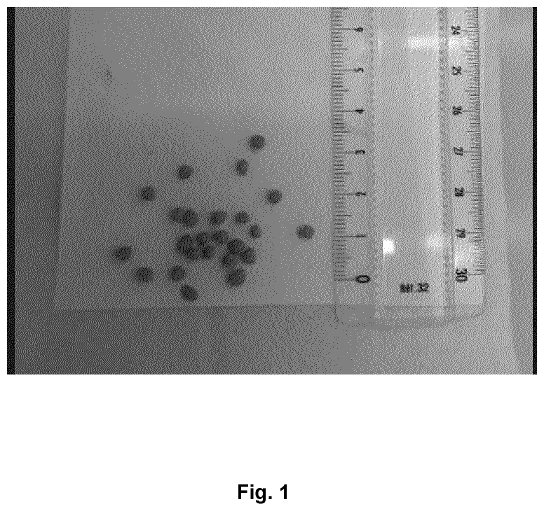

### DESCRIPTION OF THE INVENTION

The composition comprises or consists essentially of a product according to formula (I):

LiₐPS_{b}X_{c} (I)
wherein
   X represents at least one halogen element;
   a represents a number from 2.0 to 7.0, for example from 3.0 to 6.0, from 4.0 to 6.0 or from 5.0 to 6.0;
   b represents a number from 3.5 to 5.0, for example from 3.9 to 5.0 or from 4.1 to 5.0; and
   c represents a number from 0 to 3.0, for example from 0.9 to 2.9 or from 1.0 to 2.5.

According to formula (I), c may be equal to zero. In this case, the product does not comprise any halogen component and the product is according to formula (I′):

LiₐPS_{b} (I′)
wherein
   a represents a number from 2.0 to 7.0, for example from 3.0 to 7.0; and
   b represents a number from 3.5 to 5.0, for example from 3.9 to 4.9 or from 4.0 to 4.5.

According to formula (I), c may be from 0.9 to 1.1. In this case, the product may be according to formula (I″):

LiₐPS_{b}X_{c′} (I″)
wherein
c′ represents a number from 0.9 to 1.1, for example equals 1.0.

According to this formula (I″), X is preferably Cl. In this case, formula (I″) is as follows:

LiₐPS_{b}Cl_{c′} (I″)

In some embodiments, the composition comprises or consists essentially of a product according to formula (II):

Li₇₋ₓPS₆₋ₓXₓ (II)

wherein:
x is a positive number between 0.5 and 2.0;
X is an halogen selected in the group of Cl, Br and I or a combination thereof.

x is more particularly between 0.8 and 1.8. x may for instance be equal to 1.0 or to 1.5. x may also be between 0.95 and 1.05 or between 1.45 and 1.55. X is more particularly Cl, Br or a combination thereof. X may also be more particularly Cl.

In some preferred embodiments, the product is Li₆PS₅Cl, Li₄P₂S₆, Li₇PS₆, Li₇P₃S₁₁ or Li₃PS₄, more preferably Li₆PS₅Cl or Li₃PS₄.

Formulas (I), (I′), (I″) and (II) may be determined according to well-known analytical techniques.

The composition is also characterized by its size. Indeed, the size of the particles or articles of the composition is such that less than 10.0 wt % of the composition pass through a sieve of 200 μm. More preferably, the size of the particles or articles of the composition may be such that less than 10.0 wt % of the composition pass through a sieve of 400 μm, more particularly of 800 μm or even of 1000 μm. The composition generally passes through a sieve of 2 cm. The sieves preferably follow ISO 3310-1. In some embodiments, the composition is in the form of a 3 dimensional article having dimensions in 3 orthogonal directions each dimension exceeding 2 mm. In some embodiments, the composition is in the form of a 3 dimensional article having dimensions in 3 orthogonal directions each dimension exceeding 3 mm. In some other embodiments, the composition is in the form of a 3 dimensional article having dimensions in 3 orthogonal directions each dimension exceeding 5 mm. In some other embodiments, the composition is in the form of a 3 dimensional article having dimensions in 3 orthogonal directions two of them exceeding 5 mm and the third one exceeding 10 mm. The composition generally passes through a sieve of 3.5 cm. The sieves preferably follow ISO 3310-1.

The particles or the articles of the composition are constituted of particles aggregated and exhibiting a d50 which is at most 50.0 μm, for example at most 40 μm, at most 30 μm or at most 20.0 μm, more particularly between 0.1 and 20.0 μm, more particularly between 0.1 and 15.0 μm. d50 may be between 0.5 and 4.0 μm. d50 represents the particle size such that 50% (in number) of the particles present a size which is less than or equal to d50. The measurement of d50 is performed with a scanning electronic microscope (SEM) on a number of particles which is at least 150.

d50 correspond to the median of a distribution in number of the diameters of the particles. The distribution is obtained on at least one SEM image of the composition. The diameter which is taken into account is the diameter of the minimal enclosing circle. Software ImageJ may be used for the determination of d50 (this software was developed by the NIH and is available at: http://rsb.info.nih.gov or at httg://rsb.info.nih.gov/ij/download.htmI).

The particles or the articles of the composition are generally spheroidal in shape. The spheroidal shape makes it possible to easily handle the composition, especially when discharging it in an extruder.

The particles or the articles of the composition generally exhibit a sphericity ratio SR between 0.8 and 1.0, more particularly between 0.85 and 1.0, even more particularly between 0.90 and 1.0. SR may preferably be between 0.90 and 1.0 or between 0.95 and 1.0. The sphericity ratio of a particle is calculated from the measured perimeter P and area A of the projection of the particle using the following equation:

SR=4πA/P²

For an ideal sphere, SR is 1.0 and it is below 1.0 for spheroidal particles. The SR is calculated from SR is usually determined by a Dynamic Image Analysis (DIA). An example of appliance that can be used to perform the DIA is the CAMSIZER®P4 of Retsch or the QicPic® of Sympatec.

The sphericity ratio may be more particularly measured according to ISO 13322-2 (2006). The DIA generally requires the analysis of a large number of particles to be statistically meaningful (e.g. at least 500 or even at least 1000).

The article of the composition according to the invention can be any shape depending on the method used for its preparation.

In some embodiments, the article of the composition is spheroidal in shape as above defined.

When the article is a sphere, its diameter represents its dimensions in 3 orthogonal directions.

In some embodiments, the article is a sphere and its diameter exceeds 2 mm. Besides, its diameter is at most 30 mm.

In some embodiments, the article is a sphere having a diameter exceeding 2 mm and of at most 20 mm, sometimes exceeding 3 mm and of at most 15 mm, often exceeding 4 mm and of at most 10 mm.

In some other embodiments, the article of the composition is of regular cross-sectional shape including a triangle, a square, a rectangle, a hexagonal, an oval and a circle. Thus, when the regular cross-sectional shape of the article is a circle, the shape of the article is a cylinder. When the article is a cylinder, diameter represents its dimensions in 2 orthogonal directions and height its dimension in a third orthogonal direction.

In some embodiments, the article is a cylinder and its diameter exceeds 2 mm and its height exceeds 2 mm. Besides, its diameter is of at most 20 mm and its height of at most 30 mm.

In some embodiments, the article is a cylinder having a diameter exceeding 2 mm and of at most 20 mm, sometimes exceeding 3 mm and of at most 15 mm, often exceeding 4 mm and of at most 10 mm and having a height exceeding 2 mm and of at most 30 mm, sometimes exceeding 4 mm and of at most 25 mm, often exceeding 6 mm and of at most 20 mm.

In some preferred embodiments, the article is a cylinder having a diameter exceeding 4 mm and of at most 10 mm and having a height exceeding 6 mm and of at most 20 mm.

In some other embodiments, the shape of the articles of the composition is a cylinder having an oval cross-section.

Still in some other embodiments, the article of the composition is of common tablet or pill shape e.g. of regular cross-sectional shape including a triangle, a square, a rectangle, a hexagonal, an oval, a circle and a convex profile.

In some preferred embodiments, the shape of the article of the composition is a cylinder having circular or oval cross-section and a convex profile. In some more preferred embodiments, the shape of the article of the composition is a cylinder having circular cross-section with a convex profile.

The composition is characterized by its mechanical durability. Durability is representative of the capacity for the articles to resist mechanically to the collisions generated by stirring in a vial. When the articles are not resistant enough, fines are produced through the collisions between articles. The elimination of these fines by sieving during analysis is responsible for the low value of assessed durability. The durability expressed in % responds to the formula below:

Durability (%)=[1−((initial mass−mass after protocol)/initial mass)]*100.

A durability of at least 80% is desirable.

The composition is also characterized by a low emission of H₂S in given conditions. Indeed, when the composition is exposed for 50 minutes to an atmosphere composed of humid air with a relative humidity of 35%, the release r of H₂S is lower than 70 mL/g of composition, the measurement being performed at a temperature of 23° C. Thus, r is determined by a simple test which consists in exposing the composition to a humid atmosphere and in measuring the quantity of H₂S released during the first 50 minutes at which the composition is in contact with said atmosphere. The relative humidity is well known to the person skilled in the art. It corresponds to the ratio of the partial pressure of water vapor in an atmosphere air/water to the equilibrium vapor pressure of water at a given temperature. r may be lower than 50 mL/g or lower than 20 mL/g. r is generally higher than 1 mL/g.

Under the same experimental conditions, it is also possible to determine the rate of emission of H₂S expressed in mL H₂S/g/h. This rate is lower than 84 mL H₂S/g/h. This rate may be lower than 60 mL/g or lower than 24 mL/g.

The composition is also characterized by its tendency to capture water and carbon dioxide when exposed to air. Measurement of weight gain as a percentage of initial weight of the composition, after exposure to air at a relative humidity set at 35%, illustrates such behavior. Without being bonded to any theory, while capture of water triggers the release of H₂S, carbon dioxide is responsible for carbonate formation on the surface of the article which is not desired.

The presence of carbonate groups on the surface of the article can be demonstrated using infrared spectroscopy in diffuse reflectance infrared Fourier transform (DRIFT) mode. Specifically, the carbonate groups have vibrational modes v3 and v2 respectively located between 1350 and 1600 cm−1 and between 890 and 1350 cm-1.

Quantification of CO₂ adsorbed on the surface of the article can be evaluated by thermal analysis e.g. by coupling Thermogravimetric analysis (TGA) with Mass spectrometry (MS) through evaluating CO₂ release upon heating.

The composition comprises a crystalline phase which corresponds to the cubic crystal structure belonging to space group F-4 3 m. This can be confirmed by X-ray diffractometry (XRD, Cu radiation source).

The composition may also exhibit a purity P higher than 80.0%, preferentially higher than 90.0%, preferentially higher than 95.0%. P is determined by XRD. According to an embodiment, the purity is defined by:

P═I_{SE}/(I_{SE}+Iᵢₘₚ)×100

wherein:
I_{SE} the integrated area of the representative most intense peak of LiₐPS_{b}X_{c} or Li₇₋ₓPS₆₋ₓXₓ;
Iᵢₘₚ the sum of all the integrated areas of the most intense peak of each of the other crystalline phases in the composition that are detected by XRD.

The product of formula (I) or of formula (II) is the major constituent of the composition. The proportion of this product is generally higher than 80.0 wt %, preferentially higher than 90.0 wt %, preferentially higher than 95.0 wt %.

The composition may also comprise:
an amorphous phase of LiₐPS_{b}X_{c} or Li₇₋ₓPS₆₋ₓXₓ; and/or
LiX; and/or
Li₂S; and/or
Li₁₅P₄S₁₆Cl₃, and/or
Li₃PO₄.

The composition may also comprise an amorphous phase comprising the elements Li—P—S or Li—P—S—X such as Li₃PS₄ or Li₄PS₄Cl.

The XRD diffractogram may reveal the presence of LiX. For instance, a peak at 34.9°±0.1° for LiCl may be present on the XRD diffractogram. The XRD diffractogram may reveal the presence of Li₂S. For instance, a peak at 27.9°±0.1° for Li₂S may be present on the XRD diffractogram. The XRD diffractogram may reveal the presence of Li₁₅P₄S₁₆Cl₃. For instance, a peak at 29.3°±0.1° for Li₁₅P₄S₁₆Cl₃ may be present on the XRD diffractogram. See Inorg. Chem. 2020, 59, 226-234. It is noted that all XRD characteristics are given and acquired with Cu Ka wavelength.

The composition may also comprise a crystalline phase that exhibits a peak at 33.8°±0.1° and/or a crystalline product that exhibits a peak at 21.0°±0.1°.

The invention thus also relates to a composition consisting of:
the product of formula (I) or of formula (II) as disclosed above;
LiX; and/or
Li₂S; and/or
Li₁₅P₄S₁₆Cl₃, and/or
Li₃PO₄.

The invention also relates to a composition consisting of:
the product of formula (I) or of formula (II) as disclosed above;
LiX; and/or
Li₂S; and/or
Li₁₅P₄S₁₆Cl₃, and/or
a crystalline phase that exhibits a peak at 33.8°±0.1°,
a crystalline phase that exhibits a peak at 21.0°±0.1°.

The composition generally exhibits an ionic conductivity measured at 30° C. higher than 0.5 mS/cm, preferentially higher than 1.0 mS/cm, preferentially higher than 2.0 mS/cm. The ionic conductivity is generally less than 10 mS/cm, more particularly less than 7 mS/cm. In some embodiments the ionic conductivity, as measured on pressed (500 MPa) pellets by impedance spectroscopy, ranges from 1.5 to 5.0 mS/cm.

The measurement of the ionic conductivity is performed on a pressed pellet. Typically, a pressed pellet is manufactured using a uniaxial or isostatic pressure. When uniaxial pressure is applied to form the pellet, a pressure above 100 MPa, preferentially above 300 Mpa, is applied for a duration of at least 30 seconds. The measurement is done under uniaxial pressure typically between 2 MPa and 200 MPa.

Preparation of the Composition

The present invention also relates to a method of preparation of the composition described above.

In some embodiments, the composition is obtained by the process comprising the following steps:
step a): lithium sulfide (Li₂S), diphosphorus pentasulfide (P₂S₅), lithium chloride (LiCl), and lithium bromide (LiBr) are mixed;
step b): the mixture of step a) is calcined in a rotative oven at a temperature between 300° C. and 600° C., preferably between 350° C. and 500° C.;
step c): the particles from step b) are sieved to obtain the granules.

In step a), Li₂S, LiCl, LiBr and P₂S₅ are mixed together. These starting materials are generally in the powder form to obtain an intimate mixture. The amounts of these starting materials are defined so as to obtain the targeted stoichiometry. Yet, a small excess of Li₂S may be used, in particular to compensate for the potential loss of S during the calcination. The excess of Li₂S may be +10% versus the targeted stoichiometry.

In some embodiments, the starting materials of step a) are at least lithium sulfide (Li₂S) and phosphorus sulfide (P₂S₅).

In some other embodiments, the starting materials of step a) are at least lithium sulfide (Li₂S), phosphorus sulphide and LiCl.Step a) is conveniently performed by wet ball-milling the starting materials in a liquid hydrocarbon. The liquid hydrocarbon is preferably selected in the group consisting of aliphatic hydrocarbons, cycloaliphatic hydrocarbons, aromatic hydrocarbons and mixtures thereof. Aliphatic hydrocarbons are for instance hexane, heptane, octane or nonane. Cycloaliphatic hydrocarbons are for instance cyclohexane, cyclopentane or cycloheptane. Aromatic hydrocarbons are for instance benzene, toluene, ethylbenzene, xylenes or liquid naphthenes. A convenient liquid hydrocarbon that can be used is xylene.

The weight ratio hydrocarbon/mixture may be between 0.2 to 3.0, preferably 0.4 to 1.1.

The duration of the milling may be between 1 to 130 hours, preferably between 6 and 70 hours.

Step b) is preferentially performed with a mixture having been previously dried. This may be performed by using already dried starting materials or by drying the mixture. When wet-ball milling is used, drying may also be easily and conveniently performed through the evaporation of the liquid hydrocarbon. The evaporation of the liquid hydrocarbon is preferably performed at a temperature between 100° C. and 150° C., more particularly between 105° C. and 135° C. The evaporation may be performed under vacuum. The duration of the evaporation is generally between 1 and 20 hours, more particularly between 2 and 20 hours or between 3 and 7 hours. At the end of the evaporation, the mixture may comprise some residual hydrocarbon. The amount of residual hydrocarbon is generally such that C content in the mixture is below 5.0 wt %. The C content is generally between 0.5 and 3.0 wt %.

In step b), the mixture of step a) is calcined in a rotative oven at a temperature between 300° C. and 600° C., preferably between 350° C. and 500° C. Step b) is preferably performed under an inert atmosphere, for instance under an atmosphere of N2 or Ar or H2S. The duration of step b) is between 1 and 12 hours, more particularly between 3 and 6 hours. The rotative oven is spinning at a rotation speed between 0.5 to 10.0 rpm. The size of the granules may be varied through variation of the speed. The higher the rotation speed, the higher the size of the particles.

In step c), the granules are sieved to select a specific size range. This operation is performed manually or automatically. In the conditions used in the laboratory, it is advantageously performed manually.

In some other embodiments, the method of preparation of the composition according to the invention comprises the steps of:
compressing a material comprising, or consisting essentially of the product according to formula (I) or (II) by extruding said material through a die to form a rod;
cutting the rod to form the articles.

Generally, the material is compressed at a temperature ranging from 15° C. to 200° C., often ranging from 15° C. to 150° C., sometimes from 15° C. to 100° C., rarely from 15° C. to 80° C. In some embodiments the material is compressed at a temperature of 23° C.

Generally, the material is compressed at a pressure ranging from 20 MPa to 1000 MPa, often ranging from 40 MPa to 800 MPa, sometimes from 60 MPa to 600 MPa, rarely from 80 MPa to 400 MPa. In some embodiments the material is compressed at a pressure of 300 MPa. In some other embodiments the material is compressed at a pressure of 200 MPa. Still in some other embodiments the material is compressed at a pressure of 100 MPa.

In some other embodiments, the method of preparation of the composition according to the invention comprises the steps of:
mixing a material comprising, or consisting essentially of the product according to formula (I) or (II) with a liquid to obtain a dough;
compressing the dough by extruding said dough through a die to form a rod;
cutting the rod to form the articles;
drying the articles.

The dough generally comprises a total solid content ranging from 50 to 99 wt. %, often ranging from 70 to 97 wt. %, sometimes ranging from 80 to 95 wt. %.

Suitable liquids are generally selected from the group consisting of liquid hydrocarbons and liquid ketones

Suitable liquid hydrocarbons are generally selected from the group consisting of aliphatic hydrocarbons, cycloaliphatic hydrocarbons, aromatic hydrocarbons and mixtures thereof. Aliphatic hydrocarbons are for instance hexane, heptane, octane or nonane. Cycloaliphatic hydrocarbons are for instance cyclohexane, cyclopentane or cycloheptane. Aromatic hydrocarbons are for instance benzene, toluene, ethylbenzene, xylenes or liquid naphthenes.

Suitable liquid ketones are generally selected from the group consisting of aliphatic ketones, cycloaliphatic ketones, aromatic ketones and mixtures thereof. Aliphatic ketones are for instance methyl ethyl ketone, methyl isopropyl ketone, methyl isobutyl ketone, diethyl ketone or diisopropyl ketone. Cycloaliphatic ketones are for instance cyclohexanone, methyl cyclohexanone, cyclopentanone or cycloheptanone. Aromatic ketone is for instance acetophenone.

A convenient liquid that can be used is para-xylene. Another convenient liquid that can be used is methyl isobutyl ketone.

Extrusion can be performed with equipment well known by the person skilled in the art. For example, extrusion can be run using a piston extruder or using either single screw or twin screw extruder. Cutting of the rod can be made using an appropriate knife.

Depending on the extrusion die geometry, articles of the composition are of regular cross-sectional shape including a triangle, a square, a rectangle, a hexagonal, an oval and a circle. Thus, when the extrusion die geometry is an empty disc, the shape of the article is a cylinder with features as described above.

In some other embodiments, the method of preparation of the composition according to the invention comprises compressing a material comprising, or consisting essentially of the product according to formula (I) or (II) in a mold to form the article.

Generally, the material is compressed in the mold at a temperature ranging from 15° C. to 200° C., often ranging from 15° C. to 150° C., sometimes from 15° C. to 100° C., rarely from 15° C. to 80° C. In some embodiments the material is compressed in the mold at a temperature of 23° C.

Generally, the material is compressed in the mold at a pressure ranging from 20 MPa to 1000 MPa, often ranging from 40 MPa to 800 MPa, sometimes from 60 MPa to 600 MPa, rarely from 80 MPa to 400 MPa. In some embodiments the material is compressed in the mold at a pressure of 300 MPa. In some other embodiments the material is compressed at a pressure of 200 MPa. Still in some other embodiments the material is compressed at a pressure of 100 MPa.

Molding can be performed with equipment well known by the person skilled in the art. For the sake of example, molding can be run using uniaxial press or single punch tableting machines.

The material comprising, or consisting essentially of a product according to formula (I) or (II) suitable for the methods according to the invention is generally in the form of a powder.

In some embodiments, the material comprising, or consisting essentially of a product according to formula (I) or (II) suitable for the methods according to the invention is in the form of granules.

In some other embodiments, the material, comprising or consisting essentially of a product according to formula (I) or (II) can be milled to a powder before being used in the methods according to the invention.

Any material, comprising or consisting essentially of a product according to formula (I):

LiₐPS_{b}X_{c} (I)

wherein X, a, b and c are as above described, is suitable to prepare the composition according to the invention.

Any material, comprising or consisting essentially of a product according to formula (II):

Li₇₋ₓPS₆₋ₓXₓ (II),

wherein x and X are as above described, is suitable to prepare the composition according to the invention.

Use of the Composition

The composition of the invention may be used for the preparation of a composition (C) comprising (i) the product of formula (I) or (II) and (ii) at least one polymeric material (P). The composition of the invention may be used for the preparation of an electrode. The composition of the invention may also be used for the preparation of an electrolyte layer of an electrode. The composition (C) more particularly comprises:
(i) a solid material according to formula (I) or (II);
(ii) at least one polymeric material (P),
(iii) optionally at least one electro-active compound (EAC);
(iv) optionally at least one lithium ion-conducting material (LiCM) other than the solid material of the invention;
(v) optionally at least one electro-conductive material (ECM); and
(vi) optionally a lithium salt (LIS).

The composition (C) may be used for the preparation of an electrode. The composition (C) may also be used for the preparation of an electrolyte layer of an electrode. The electrode may be a positive electrode or a negative electrode.

The function of the polymeric material (P) is to hold together the components of composition (C). The polymeric material (P) is usually inert. It preferably should be also chemically stable and facilitate the electronic and ionic transport. The polymeric material is well known in the art.

Non-limitative examples of polymeric materials (P) include notably: (1) VDF or TFE based polymers, notably in the form of copolymers, block copolymers or graft copolymers; (2) hydrogenated or non-hydrogenated diene-based rubber polymers, notably in the form of block copolymers and graft polymers such as polyisobutylene (FIB), styrene-butadiene rubber (SBR), (hydrogenated) acrylonitrile butadiene rubber ((h)NBR), styrene-ethylene-butylene-styrene (SEBS) and the like; (3) polymers comprising at least one alkyl (meth)acrylate, notably in the form of copolymers, block copolymers and graft copolymers, such as polymethylmethacrylate (PMMA), polybutylacrylate (BA), styrene-butylacrylate (ST-BA), styrene methylacrylate (ST-MA), butylacrylate-acrylonitrile (BA-CN) and the like; (4) polysaccharide based polymers, copolymers, block copolymers and graft copolymers such as carboxymethylcellulose (CMC), guar and the like; (5) polymers based on acrylonitrile, notably in the form of copolymers block copolymers and graft polymers such as poly(acrylonitrile) (PAN), acrylonitrile-methylacrylate (PAN-MA), styrene-acrylonitrile (SAN) acrylonitrile-styrene-acrylate (ASA) and the like; (6) polyamideimide (PAI) polymers, copolymers, block copolymers and graft polymers.

The polymeric material (P) may be selected in the list consisting of vinylidenefluoride (VDF)-based (co)polymers. The polymeric material (P) may more particularly be a copolymer comprising or consisting of units of VDF and hexafluoropropylene (HFP).

The polymeric material (P) may be selected in the list consisting of the optionally hydrogenated thermoplastic elastomers based on styrene. The polymeric material (P) may more particularly be a styrene-butadiene rubber (SBR) or a styrene-ethylene-butylene-styrene (SEBS).

The polymeric material (P) may be selected in the list consisting of polymers comprising units of acrylonitrile. The polymeric material (P) may more particularly be a copolymer of acrylonitrile, butadiene and/or butyl acrylate.

The proportion of the product of formula (I) or (II) in the composition (C) is usually between 0.1 wt % and 99.9 wt %, based on the total weight of the composition. In particular, notably when composition (C) is suitable for the preparation of an electrode, this proportion may be between 1.0 wt % and 60.0 wt %, more particularly between 5.0 wt % and 30.0 wt %. Notably when composition (C) is suitable for the preparation of a separator, this proportion may be between 90.0 wt % and 99.9 wt %, more particularly between 93.0 wt % to 99.5 wt %.

The electro-active compound (EAC) denotes a compound which is able to incorporate or insert into its structure and to release lithium ions during the charging phase and the discharging phase of an electrochemical device. An EAC may be a compound which is able to intercale and deintercalate into its structure lithium ions. For a positive electrode, the EAC may be a composite metal chalcogenide of formula LiMeQ₂ wherein:
Me is at least one metal selected in the group consisting of Co, Ni, Fe, Mn, Cr, Al and V;
Q is a chalcogen such as 0 or S.

The EAC may more particularly be of formula LiMeO₂. Preferred examples of EAC include LiCoO₂, LiNiO₂, LiMnO₂, LiNiₓCo₁₋ₓO₂ (0<x<1), LiNiₓCo_{y}Mn_{z}O₂ (0<x, y, z<1 and x+y+z=1) for instance LiNi_{1/3}Mn_{1/3}Co_{1/3}O₂, LiNi_{0.6}Mn_{0.2}Co_{0.2}O₂, LiNi_{0.8}Mn_{0.1}Co_{0.1}O₂, Li(NiₓCo_{y}Al_{z})O₂ (x+y+z=1) and spinel-structured LiMn₂O₄ and Li (Ni_{0.5}Mn_{1.5})O₄.

The EAC may also be a lithiated or partially lithiated transition metal oxyanion-based electro-active material of formula M₁M₂(JO₄)_{f}E_{1-f}, wherein:
M₁ is lithium, which may be partially substituted by another alkali metal representing less that 20% of M₁,
M₂ is a transition metal at the oxidation level of +2 selected from Fe, Co, Mn, Ni or mixtures thereof, which may be partially substituted by one or more additional metals at oxidation levels between +1 and +5 and representing less than 35% of the M₂ metals, including 0;
JO₄ is any oxyanion wherein J is either P, S, V, Si, Nb, Mo or a combination thereof;
E is a fluoride, hydroxide or chloride anion;
f is the molar fraction of the JO₄ oxyanion, generally comprised between 0.75 and 1.

The M₁M₂(JO₄)_{f}E_{1-f} electro-active material as defined above is preferably phosphate-based. It may exhibit an ordered or modified olivine structure.

For a positive electrode, the EAC may also be sulfur or Li₂S.

For a positive electrode, the EAC may also be a conversion-type materials such as FeS₂ or FeF₂ or FeF₃.

For a negative electrode, the EAC may be selected in the group consisting of graphitic carbons able to intercalate lithium. More details about this type of EAC may be found in Carbon 2000, 38, 1031-1041. This type of EAC typically exists in the form of powders, flakes, fibers or spheres (e.g. mesocarbon microbeads).

The EAC may also be: lithium metal; lithium alloy compositions (e.g. those described in U.S. Pat. No. 6,203,944 and in WO 00/03444); lithium titanates, generally represented by formula Li₄Ti₅O₁₂, these compounds are generally considered as “zero-strain” insertion materials, having low level of physical expansion upon taking up the mobile ions, i.e. Li⁺, lithium-silicon alloys, generally known as lithium silicides with high Li/Si ratios, in particular lithium silicides of formula Li_{4.4}Si and lithium-germanium alloys, including crystalline phases of formula Li_{4.4}Ge. EAC may also be composite materials based on carbonaceous material with silicon and/or silicon oxide, notably graphite carbon/silicon and graphite/silicon oxide, wherein the graphite carbon is composed of one or several carbons able to intercalate lithium.

The ECM is typically selected in the group consisting of electro-conductive carbonaceous materials and metal powders or fibers. The electron-conductive carbonaceous materials may for instance be selected in the group consisting of carbon blacks, carbon nanotubes, graphite, graphene and graphite fibers and combinations thereof. Examples of carbon blacks include ketjen black and acetylene black. The metal powders or fibers include nickel and aluminum powders or fibers.

The lithium salt (LIS) may be selected in the group consisting of LiPF₆, lithium bis(trifluoromethanesulfonyl)imide, lithium bis(fluorosulfonyl)imide, LiB(C₂O₄)₂, LiAsF₆, LiClO₄, LiBF₄, LiAlO₄, LiNO₃, LiCF₃SO₃, LiN(SO₂CF₃)₂, LiN(SO₂C₂F₆)₂, LiC(SO₂CF₃)₃, LiN(SO₃CF₃)₂, LiC₄F₉SO₃, LiCF₃SO₃, LiAlCl₄, LiSbF₆, LiF, LiBr, LiCl, LiOH and lithium 2-trifluoromethyl-4,5-dicyanoimidazole.

The electrode typically comprises:
a metal substrate;
directly adhered onto said metal substrate, at least one layer made of the composition (C).

The thickness of the electrode is not particularly limited and should be adapted with respect to the energy and power required in the application. For example, the thickness of the electrode may be between 0.01 mm to 1,000 mm.

The composition (C) may also be used in the preparation of a separator. A separator is an ionically permeable membrane placed between the anode and the cathode of a battery. Its function is to be permeable to the lithium ions while blocking electrons and assuring the physical separation between the electrodes.

The separator of the invention typically comprises:
a solid material according to formula (I) or (II);
at least one polymeric binding material (P) as disclosed above;
optionally at least one lithium salt (LIS) as disclosed above; and
optionally at least one plasticizer.

The electrode and the separator may be prepared using methods well-known to the skilled person. This usually involves mixing the components of composition (C) in an appropriate solvent and removing the solvent.

Appropriate solvents are inert toward the composition of the invention and thus not dissolving it. Solvents used for the preparation of the solid material of the invention may be used for the preparation of the electrodes or separator layers; such as for instance xylene.

For instance, the electrode may be prepared by the process which comprises the following steps:
a slurry comprising the components of composition and at least one solvent is applied onto the metal substrate;
the solvent is removed.

Usual techniques known to the skilled person are the following ones: coating and calendaring, dry and wet extrusion, 3D printing, sintering of porous foam followed by impregnation. Usual techniques of preparation of the electrode and of the separator are provided in Journal of Power Sources, 2018 382, 160-175. Other techniques such as extrusion, paste extrusion, (electro)spray coating, kneading followed by calendaring may be used.

Should the disclosure of any patents, patent applications, and publications which are incorporated herein by reference conflict with the description of the present application to the extent that it may render a term unclear, the present description shall take precedence.

### EXAMPLES

XRD Analysis

The XRD diffractograms of the powders were acquired on a XRD goniometer in the Bragg Brentano geometry, with a Cu X Ray tube (Cu Kalpha wavelength of 1.5406 Å). The setup may be used in different optical configurations, i.e. with variable or fixed divergence slits, or Soller slits. A filtering device on the primary side may also be used, like a monochromator or a Bragg Brentano HD optics from Panalytical. If variable divergence slits are used; the typical illuminated area is 10 mm×10 mm. The sample holder is loaded on a spinner; rotation speed is typically 60 rpm during the acquisition. Tube settings were operating at 40 kV/30 mA for variable slits acquisition and at 45 kV/40 mA for fixed slits acquisition with incident Bragg Brentano HD optics. Acquisition step was 0.017° per step. Angular range is typically 5° to 90° in two theta or larger. Total acquisition time was typically 30 min or longer. The powders are covered by a Kapton film to prevent reactions with air moisture.

The XRD purity P is calculated with the following formula:

P═I_{SE}/(I_{SE}+Iᵢₘₚ)×100

wherein:
I_{SE} the integrated area of the representative most intense peak of LiₐPS_{b}X_{c} or Li₇₋ₓPS₆₋ₓXₓ;
Iᵢₘₚ the sum of all the integrated areas of the most intense peak of each of the other crystalline phases in the composition that are detected by XRD.

Determination of H₂S Emission

The preparation of the sample is carried out in a dry Ar glove-box (moisture level <5 ppm, O₂ level <5 ppm). The sample (between 350 and 700 mg for powder and compressed articles, respectively) is placed in an open circular holder with a circular surface of 4.02 cm². The sample (100 mg for granules) is placed in an open circular holder. Then, the holder is placed on a zirconia pot where it can be isolated from the atmosphere. The zirconia pot is transferred from the dry-argon glove box to a room air operated one that is used for the H₂S quantification test. Relative humidity is set at 35% at room temperature (23° C.) (corresponding to a Dew Point of 6.7° C.). Humidity is measured by a Dew Point probe from Mitchell Instruments (EA2-TX-100). Humidity within the glove-box can be controlled by the inlet of pre-dried compressed air. The atmosphere within the glove-box is homogenized by means of two fans. Once the atmosphere is stable, the zirconia pot is opened, exposing the sample to the controlled humid atmosphere. H₂S quantification is carried out by a Sensorcon sensor (Industrial Pro—H₂S Pro). The experiment is carried out for 50 min at the end of which the zirconia pot is again closed.

Determination of Carbonates

Identification of carbonates by Diffuse reflectance infrared Fourier transform spectroscopy (DRIFTS) studies can be performed on a Bruker FTIR (MIR) Vertex 70 spectrometer. Measurements are conducted using a high-temperature reactor chamber and Praying Mantis diffuse reflectance accessory (Herrick). The reactor chamber is equipped with KBr windows and counts with a type K thermocouple that measures the temperature close to the powder. Different gases can be dosed via mass flow controllers (Bronkhorst). Measurements are carried out at 25° C. and atmospheric pressure under a 25 Nml/min Argon flow used to inertize the analysis chamber and preserve the sample from external moisture. All spectra are recorded using an acquisition time of 1 min and 2 cm⁻¹ spectral resolution. A total of 250 scans are recorded and averaged between 600 and 6000 cm⁻¹. The ratio between the considered groups is calculated by taking the maximum intensity peak in the spectral region.

The quantification of CO₃ can be made by elemental analysis using a C—S apparatus (Horiba EMIA 320-V2). 200 mg of the sample are introduced together with a combustor accelerator (Lecocel, iron and tin) in a ceramic crucible. The crucible is then heated up in an oven up to 1100° C. for 10 min. The main products of combustion are CO and CO₂ that are analyzed by a non-dispersive infrared (NDIR) analyzer. The amount of CO₃ is then calculated from the measured CO and CO₂.

The qualitative comparison of CO₃ can also be performed by using related thermal analysis techniques coupled to evolved gas analysis. Thermogravimetric analysis coupled to a mass spectrometer (TGA-MS− TGA/DSC3+ LF1600 Mettler and Thermostar GSD 350 from Pfeiffer Vacuum) can be used for this purpose. 40 mg of the sample are placed in an alumina crucible and heated from room temperature to 600° C. at 10° C./min under 50 ml/min N2 flow. The qualitative estimation of CO₃ is performed by integrating the CO and CO₂ peaks detected by MS. Signals are normalized by the total pressure of the system.

Conductivity Measurements

Before the impedance spectroscopy measurements, powder samples were cold-pressed at 500 MPa in an Ar filled glovebox. The conductivity was acquired on pellets done using a uniaxial press operated at 500 MPa. Pelletizing was done using a lab scale uniaxial press in glovebox filled with moisture free Argon atmosphere. Two carbon paper foils (Papyex soft graphite N998 Ref: 496300120050000, 0.2 mm thick from Mersen) are used as current collector. Pellets with their carbon electrodes attached are then loaded into air-tight sample holders and a pressure of 40 MPa is applied on the sample holder for the measurement. The impedance spectra are acquired on a Biologic VMP3 device and the control of temperature is ensured by a Binder climatic chamber. Duration of two hours is set to allow the temperature to be equilibrated between two measurements. Impedance spectroscopy is acquired in PEIS mode with an amplitude of 20 mV and a range of frequencies from 1 MHz to 1 kHz (25 points per decade and a mean of 50 measurements per frequency point). Temperature was varied from −20° C. to 60° C. with 10° C. intervals.

Determination of Compaction Rate

The compaction of the obtained article was calculated by measuring the volume of the article after densification. The diameter of the article corresponds to the used dye (e.g. 13 mm) and the thickness was measured by using a digital micrometer. Weighting the article of measured volume leads to measured real density ρᵣₑₐₗ.

The theoretical density is calculated by XRD by taking into account the density of the crystal lattice by the following equation:

ρ_{theoretical}=(z·M)/(Vₘ·N_{A})

where z is the number of atoms per unit cell, M is the molecular weight of the product, Vₘ is the volume per unit cell (cm³/cell) and N_{A} is Avogadro's number (6.023·10²³).

Then, the rate of compaction (%) was calculated according to the following equation:

Compaction (%)=(ρᵣₑₐₗ/ρ_{theoretical})×100

Particle Size Distribution Measurement

The Particle Size Distribution (PSD) of the powders was evaluated using laser diffraction measurement. For this purpose, the powder was stirred in para-xylene. The solution was filtered on a 800 μm sieve and introduced in a Malvern Mastersizer 3000. Data was treated with the optical model of Fraunhofer.

### Example 1: Preparation of a Composition with x=1 (Li₆PS₅Cl) (Granules)

step a): 22.7 g of LiCl (Sigma-Aldrich, purity>99%); 59.5 g of P2S5 (Sigma-Aldrich, purity>99%) and 61.5 g of Li₂S (Lorad, 100%, 200 mesh) are successively weighed and added in a glass container. The powders are homogenized by gentle manual mixing. They are then added to a 500 mL zirconia bowl (Across) containing 480 g of ZrO₂ balls (5 mm, Across). 106.3 g of para-xylene (Sigma-Aldrich, purity>99%, dry) is then added and used to rinse the powder from the glass container directly inside the zirconia bowl. The bowl is rapidly sealed to prevent any para-xylene evaporation. Wet-ball milling is conducted with a Across PQ-N2 planetary ball-mill. After 65 h of milling at 580 rpm, a pale yellow/beige paste is obtained.

The paste is transferred in a dry alumina crucible and dried under dynamic vacuum at 130° C. to remove the para-xylene. The para-xylene is condensed by ice water and the drying is continued until the volume of condensed xylene equals the volume introduced at the wet ball-milling step. After 5 hours of drying, the milling balls are separated from the light beige powder through sieving at 4 mm

step b): the dried mixture is charged under dry air (dew point <−15° C.) in a quartz reactor. The reactor is then inserted in a rotative oven and the product is crystallized at 490° C. during 12 hours (heating ramp 1.5° C./min) with a rotation of 9 rpm under N₂ flow (30 L/h). It is allowed to cool down to 50° C. under same N2 flow and rotation. The final product is in the form of granules. The granules are polydisperse in size, with sizes ranging from few hundreds of microns to few millimeters.

### Exemple 1A

The granules of exemple 1 are manually sieved with a 800 μm sieve. Only the fine particles are kept. They are again sieved with a 400 μm sieve. Only the large particles are kept (portion from 400 to 800 μm). The granules thus obtained emit 70 mL H₂S/g. This corresponds to a rate of emission of H₂S of 84 mL H₂S/g/h.

### Exemple 1 B

The granules of exemple 1 are manually sieved with a 800 μm sieve. Only the large particles are kept. the granules thus obtained emit 45 mL H₂S/g. This corresponds to a rate of emission of H₂S of 54 mL H₂S/g/h.

### Exemple 1C

The granules of exemple 1 are manually separated to isolate the granules with a diameter >4 mm. The granules thus obtained emit 10 mL H₂S/g. This corresponds to a rate of emission of H₂S of 12 mL H₂S/g/h.

### Comparative Example 1

The granules of example 1 are manually sieved with a 400 μm sieve. Only the fine particles are kept. They are again sieved with a 200 μm sieve. Only the large particles are kept (=portion from 200 to 400 μm). The granules thus obtained emit 80 mL H₂S/g.

### Comparative Example 2

The granules of example 1 are manually sieved with a 200 μm sieve. Only the fine particles are kept. The granules thus obtained emit 80 mL H₂S/g

### Example 2: Preparation of a Material with x=1 (Li₆PS₅Cl) (Powder)

In a first step, 22.7 g of LiCl (Sigma-Aldrich, purity>99%); 59.5 g of P₂S₅ (Sigma-Aldrich, 20 purity>99%) and 61.5 g of Li₂S are added to ZrO₂ balls (10 mm) into a zirconia jar. 130 g of para-xylene (Sigma-Aldrich, purity>99%, dry) are then added. The tight jar is rapidly sealed to prevent any para-xylene evaporation. Wet-ball milling is conducted with a planetary ball-mill. After 7 h of milling at 200 rpm, a paste is obtained.

In a second step, the paste is transferred in a dry alumina crucible and dried under dynamic vacuum at 130° C. in an oven to remove the solvent. After 5 hours of drying, the milling balls are separated from the dried powder through sieving at 4 mm.

In a third step, the dried mixture is charged under dry air (less than 300 ppm of water) in an alumina reactor. The reactor is then inserted in a rotative oven and the product is crystallized at 480° C. during 5 hours with a rotation of 1 rpm under N₂ flow (20 L/h). The reactor is then cooled down without rotation.

The final product is in the form of a polydisperse powder with some agglomerates of different sizes. The finished product is obtained by dry homogenization.

PSD of the resulting powder measured as above described was:
d10-value=9.4 μm
d50-value=29.3 μm
d90-value=65.6 μm7

### Example 3: Preparation of Article of the Composition

Articles were prepared using uniaxial press and a cylindrical mold having a 13 mm diameter. 350 mg of the powder of example 2 were introduced in the mold and uniaxial pressure was applied to form the article. Pressure was applied for a duration of 2 minutes at temperature of 23° C. Cylindrical articles with height of 2.1 mm were obtained.

Weight gain of the article was measured after exposure to humid air with a relative humidity set at 35% at room temperature during 120 minutes and is expressed in table 1 below as percentage of the weight of the article before exposure.

TABLE 1
Effect of pressure onto compaction
(%) and onto weight gain (wt. %)

| Run | Pressure MPa | Compaction (%) | Weight gain (wt. %) |
|---|---|---|---|
| 1 | 0 (powder) | 0 | 24 |
| 2 | 200 | 73 | 11 |
| 3 | 300 | 77 | 8 |
| 4 | 500 | 85 | 6 |

It is clear from table 1 that increasing the pressure applied, increases the % of compaction of the resulting article and decreases the weight gain of said article exposed to humid air with a relative humidity set at 35% and at 23° C.

This is an indication that the article is less subject to weight increase due to contact with water and carbon dioxide when its compaction increases. Accordingly, applying a higher pressure results in an article wherein a reduced amount of water and of carbonate groups, resulting from the contact with carbon dioxide, is present.

TABLE 2
Effect of pressure onto compaction
(%) and onto H₂S release (ml/g)

| Run | Pressure MPa | Compaction (%) | ml H₂S/g (120 min.) |
|---|---|---|---|
| 1 | 0 (powder) | 0 | 34 |
| 2 | 200 | 73 | 6.7 |
| 3 | 300 | 77 | 5.7 |
| 4 | 500 | 85 | 3.5 |

Results from table 2 reveal that increasing the pressure applied, increases the % of compaction of the resulting article and decreases the H₂S release of said article exposed to humid air with a relative humidity set at 35% and at 23° C.

Accordingly, applying a higher pressure results in an article where a reduced amount of H₂S is released.

Redispersion of Articles

The created articles of Runs 2-4 were turned into powder by manual milling by using a Zirconium mortar and pestle. The milling was performed for 5 min in a controlled atmosphere (glove-box: moisture level <5 ppm, 02 level <5 ppm).

Milled articles according to the invention result in powder the Particle Size Distribution (PSD) of which was evaluated using laser diffraction measurement. A suitable redispertion of the powder obtained by milling the articles of the invention leads to a powder having a PSD evaluated by laser diffraction measurement in para-xylene close to the PSD of the powder obtained e.g. after the synthesis as disclosed in example 2.

Then powder samples from Runs 1-4 were cold-pressed using a uniaxial press operated at 500 MPa in glovebox filled with moisture free Argon atmosphere and the conductivity was acquired on the resulting pellets. Results show that the conductivity of the different powders issued from the milling of articles of Runs 2-4 is similar to the conductivity of original powder of Run 1 i.e. powder synthesized as described in Example 2. Therefore, preparation of the article according to the invention has no impact onto the ionic conductivity of the composition after reduction of size of the article by milling.

1. A composition comprising a product according to formula (I):
LiₐPS_{b}X_{c} (I)
wherein
X represents at least one halogen element;
a represents a number from 2.0 to 7.0;
b represents a number from 3.5 to 6.0; and
c represents a number from 0 to 3.0;
wherein the composition is in the form of particles or articles a size of which being such that less than 10.0 wt % of the composition passes through a sieve of 200 μm.

2. The composition according to claim 1, wherein the product is according to formula (II):
Li₇₋ₓPS₆₋ₓXₓ (II)
wherein:
x is a positive number between 0.5 and 2.0; and
X is a halogen selected from the group of Cl, Br and I or a combination thereof.

3. The composition according to claim 1, wherein the composition consists essentially of the product according to formula (I).

4. The composition according to claim 1, wherein the product is Li₆PS₅Cl, Li₄P₂S₆, Li₇PS₆, Li₇P₃S₁₁ or Li₃PS₄.

5. The composition according to claim 1, wherein the composition further comprises:
an amorphous phase of LiₐPS_{b}X_{c} or Li₇₋ₓPS₆₋ₓXₓ, wherein x is a positive number between 0.5 and 2.0, and X is a halogen selected from the group of Cl, Br and I or a combination thereof; and/or
LiX; and/or
Li₂S; and/or
Li₁₅P₄S₁₆Cl₃; and/or
Li₃PO₄.

6. The composition according to claim 1 consisting of:
the product of formula (I) or Li₇₋ₓPS₆₋ₓXₓ, wherein x is a positive number between 0.5 and 2.0, and X is a halogen selected from the group of Cl, Br and I or a combination thereof;
LiX; and/or
Li₂S; and/or
Li₁₅P₄S₁₆Cl₃; and/or
Li₃PO₄.

7. The composition according to claim 1 wherein the size of the particles is such that less than 10.0 wt % of the composition passes through a sieve of 400 μm.

8. The composition according to claim 1, wherein the composition is in the form of a 3 dimensional article having dimensions in 3 orthogonal directions each dimension exceeding 2 mm.

9. The composition according to claim 1 wherein a proportion of the product of formula (I) or —Li₇₋ₓPS₆₋ₓXₓ, wherein x is a positive number between 0.5 and 2.0, and X is a halogen selected from the group of Cl, Br and I or a combination thereof in the composition is higher than 80.0 wt %.

10. The composition according to claim 1 characterized by a release r of H₂S lower than 70 mL/g of composition, r being determined by exposing the composition to an atmosphere composed of humid aid with a relative humidity of 35% and measuring a quantity of H₂S released during first 50 minutes at which the composition is in contact with said atmosphere, wherein a temperature is set at 23° C.

11. The composition according to claim 1 wherein the particles or the articles of the composition are constituted of particles aggregated exhibiting a d50 between 1 and 20 μm wherein d50 represents a particle size such that 50% (in number) of the particles present a size which is less than or equal to d50.

12. The composition according to claim 1, wherein the particles or the articles of the composition are spheroidal in shape and exhibit a sphericity ratio SR between 0.8 and 1.0, wherein SR is calculated from a measured perimeter P and area A of a projection of the particle using the following equation:
SR=4πA/P²
and wherein SR is determined by a Dynamic Image Analysis (DIA), notably pursuant to ISO 13322-2 (2006).

13. The composition according to claim 1, wherein the article of the composition is in a shape of a cylinder having a circular cross section.

14. A method of preparation of a composition as claimed in claim 1 comprising the following steps:
step a): mixing lithium sulfide (Li₂S), diphosphorus pentasulfide (P₂S₅), lithium chloride (LiCl), and lithium bromide (LiBr);
step b): calcinating the mixture of step a) in a rotative oven at a temperature between 300° C. and 600° C.; and
step c): sieving the particles resulted from step b) to obtain granules.

15. A method of preparation of the composition as claimed in claim 13 comprising the steps of:
compressing a material comprising the product according to formula (I) by extruding said material through a die to form a rod; and
cutting the rod to form the articles.

16. A method of preparation of the composition as claimed in claim 13 comprising the steps of:
mixing a material comprising the product according to formula (I) with a liquid to obtain a dough;
compressing the dough by extruding said dough through a die to form a rod;
cutting the rod to form the articles;
drying the articles.

17. A method of preparation of the composition as claimed in claim 1 comprising compressing a material comprising the product according to formula (I) in a mold to form the articles.

18. The composition as claimed in claim 1 further comprising at least one polymeric material (P).

19. An electrode or an electrolyte layer of an electrode formed from the composition of claim 1.

20. A separator formed from the composition of claim 1.
